(19) United States
(12) Patent Application Publication
(10) Pub. No.: US 2008/0017031 A1
(43) Pub. Date: Jan. 24, 2008

(54) Gas Filtration System and Filter Cleaning Method

(76) Inventor: Chau Thien Vo, Roxboro (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/597,823

(22) PCT Filed: Feb. 14, 2005
(86) PCT No.: PCT/CA05/00190

§ 371 Date: Jun. 8, 2007

Related U.S. Application Data
(60) Provisional application No. 60/543,926, filed on Feb. 13, 2004.

(51) Int. Cl. B01D 29/66; B01D 35/16; B01D 46/04; B01D 53/34

(52) U.S. Cl. 95/148; 96/136; 96/144

(57) ABSTRACT

An apparatus (10, 200, 250, 250′) for filtering particulates from a gas, comprising a casing (22, 24, 202) defining an inner cavity having an inlet (30, 210, 260) adapted to receive a flow of gas, such that gas enters the inner cavity, and an outlet (40, 231, 281) through which gas exits the inner cavity. A filter (32, 213, 262) is associated with the outlet (40, 231, 281) such that gas exiting the inner cavity through the outlet (40, 231, 281) passes through the filter (32, 213, 262). The filter (32, 213, 262) is adapted to retain particulates beyond a predetermined size from a gas flowing therethrough. A back-pulse generator (42, 223, 270) is positioned downstream of the filter (32, 213, 262). The back-pulse generator (42, 223, 270) is adapted to cause a reverse flow of gas through the outlet (40, 231, 281) and into the inner cavity of the casing, so as to dislodge a portion of the particulates retained in the filter (32, 213, 262) into the inner cavity.

### CROSS-REFERENCE TO RELATED APPLICATION

This patent application claims priority on U.S. Provisional Application No. 60/543,926, filed on Feb. 13, 2004, by the present Applicant.

### BACKGROUND OF THE INVENTION

1. Field of the Invention

The present invention generally relates to a filtration system and method of use of the filtration system and, more particularly, to a back-pulse system providing filter cleaning. In another aspect, the present invention relates to a filtration system and method for use in the printing industry to filter out byproducts of plate-making processes from the air.

2. Background Art

Gas/air filtration systems are employed to filter gas-borne/airborne contaminants from the gas/air. These systems typically comprise an enclosure with an intake allowing gas/air into the system, one or more filters for particulate and/or chemical vapor capture, a flow-creating device (e.g., fans or blowers), all of which cooperate to filter particulate contaminants from the gas/air.

Some air filtration systems use HEPA filters (i.e., High Efficiency Particulate Arrestation filters, having 99.97 to 99.99% efficiency at 0.3 microns) to permit a superior level of filtration, and are employed especially to provide particulate reduced gas/air, for instance to pressurize an enclosed space so as to make the enclosed space generally free of exterior environmental airborne contaminants. Applications include providing clean air to pre-press equipment, hospital clean-rooms, etc. Likewise, such systems can be used to extract contaminated air from an enclosed space in which resides the contamination source. In addition, such systems may be used to filter and recirculate the gas/air within the surrounding environment.

The order of the components of such systems is generally not important for the system to function, however systems that require a high level of efficiency, especially in areas with high particle count or particulate sensitive equipment, benefit from placing a primary particulate filter (a cellulose or HEPA filter) in advance of the other components (e.g., HEPA filter, flow-creating device, carbon chemical filter, and the like) to prevent contamination of these components from the particulate by capturing most particulate upstream of these components. For example, a HEPA filter can be employed before an activated carbon filter to capture acrolein to extend the lifespan of the activated carbon filter. These primary filters are subject to a greater degree of particulate saturation and therefore often have the shortest lifespan and need replacement often.

There are some environments or processes where the quantity and concentration of particulate matter in the gas/air are very high [e.g., carbon black production, laser ablation plate imaging systems, spray powder recovery and desert environments (sand and dust)]. In such applications, the filtration system typically features an integrated system which cleans the filter in order to extend the life of the filter, without having to remove and replace the filter.

Methods employed to extend the lifespan of the filter include back-pulse systems using compressed air jets to dislodge particulate from the filter outward against the nominal direction of the filtrate flow. The compressed air is typically provided by an external air compressor or reservoir. Various apparatuses or devices, such as a funnel leading to a conveyor that transfers material to an enclosed chamber, are employed to capture particulate blown back out of the filter to prevent exterior contamination or re-saturation of the filter with this particulate.

Other gas/air filtration systems having back-pulsing systems which depend on compressed air to clean the filter are effective at extending the life of a filter by dislodging the particulate material from the filter. However, the compressed air jets are often located on the filtrate side of the filter, whereby airborne contaminants may be introduced into the filtrate. If the intake air of the compressor is not filtered by a filtration system as efficient in terms of particulate arrestation as the primary filtration system, then the filtrate of the primary filtration system will be contaminated.

Condensate in the compressor output may also add to the contamination of the filtrate. In addition, increased humidity levels in the compressed air may have adverse affects on the filtration medium and increase the adhesion of the particulate matter to the filtration medium, thus making it more difficult to clean the filter with a back pulse of air. It may also be an inconvenience or impractical to have an external compressor with air lines going to the back pulsing system within the air filtration unit.

Using compressed air/gas tanks that store pressurized gas/air may also be impractical because of the difficulty in preventing slow leaks. It may also be inconvenient to refill the tanks. In addition, some filtration systems use multiple filter cells which would each have to be supplied with a source of compressed air. This requires a complex routing of air lines and installation of multiple valves, while resulting in an increased potential for leaks.

In the printing industry, a pre-press process involves the thermal laser ablation of lithographic printing plates (e.g., using computer-to-plate equipment) in order to create images on those plates. The plates will be used thereafter to transfer an ink image onto a medium. The laser ablation process creates undesired byproducts. For example, particulates referred to as “carbon black,” as well as chemical vapors and odors deriving thereof, such as aldehyde, formaldehyde and acrolein, result from the laser ablation of the plates.

Byproducts of the laser ablation process include carbon black and various volatile organic compounds that are considered hazardous to human health. Accordingly, filtration systems are often associated with pre-press equipment in order to remove the byproducts from the air.

Various equipment is used to filter particulate matter and adsorb chemical vapors from the air and/or to maintain environmental conditions at acceptable levels for both equipment and human exposure, in a pre-press environment, for example. Suitable filters (e.g., dust filters, HEPA filters) are used for particulate filtration, whereas chemical filters (e.g., active-carbon filters) are used for the adsorption of chemical vapors.

A specified filtration rate must be maintained for the filtration system to keep both the environment and the equipment clean. The rate of filtration and adsorption is reduced as the medium for particulate filtration becomes saturated with particulate because of a reduction of airflow. In addition, a conventional unidirectional airflow particulate filter has a lifespan defined by the point at which the specified filtration rate can no longer be achieved due to restrictive clogging caused by saturation with particulate matter. Chemical filters have a lifespan determined by the inability to adsorb more chemical vapor as the media for adsorption becomes saturated with chemicals or clogged with particulate matter. However, the saturation of the chemical filter does not affect the rate of airflow.

For example, particulate filters become clogged with particulates, thereby restricting airflow necessary to maintain specified filtration rates, whereby the particulate filters require changing. In the case of laser ablation byproducts, filters require frequent changing because of clogging by “carbon black” particulates. The changing of filters causes an exposure of maintenance personnel to the particulates (e.g., carbon black) of the filters. Moreover, the changing of filters possibly involves the release of carbon-black particulates into the surrounding environment.

Quatro Air Technologies has a filter system model AMS-300EP, which houses in a single cabinet several filters for particulate and a filter for chemical vapors stacked one on top of the other, with a single access at one end of the cabinet. It only may be necessary, however, to change one of these filters at any given time. However, the configuration of the assembly of filters within the cabinet necessitates handling of other filters that are on top of the filter that needs to be changed. When the AMS-300EP is used in an application such as the laser ablation plate imaging process, the AMS-300EP requires frequent filter replacement due to the high volume of carbon black generation within the computer to plate (CTP) equipment and the lack of a back pulsing system to clean filters.

In view of these issues, it would be desirable to provide a method of back-pulsing gas/air through a particulate filter within a gas/air filtration system, without the need for compressed gas/air, thus providing a practical means of increasing the life of the filter in order to reduce recurring costs from filter replacement, to reduce exposure of the contents of the filters to maintenance personnel, and to reduce the costs of maintenance by reducing frequency of maintenance. Design, production, installation, and service/maintenance would also be simplified by the omission of the compressed air/gas lines, valves, pressure sensors, since the associated routing, access, leak proofing, leak detection measures and challenges would be nullified. It would also be desirable to provide a filtration system in which the exposure of the maintenance personnel to laser ablation byproducts collected by the filters is limited.

### SUMMARY OF INVENTION

It is a feature of the present invention to provide a novel filtration system.

It is a further feature of the present invention to provide a back-pulsing system that discharges particulate captured in particulate filters to prolong the usable life of filters.

It is a further feature of the present invention to provide a back-pulsing system utilizing an air displacement generator which does not require an internal or external mechanical air/gas compressor, air/gas nozzles, air/gas lines, or compressed air/gas reservoirs.

It is a further feature of the present invention to provide a back-pulsing system that substantially overcomes the disadvantages of the prior art.

It is a further feature of the present invention to provide a back-pulsing system utilizing an electromechanical vortex generator that can be powered by and controlled with electricity and electrical signals respectively, to push gas/air through the filter in order to clean the filter.

It is a still further feature of the present invention to include a novel back-pulse trap to capture particulate blown back to prevent exterior contamination or re-saturation of the filter with this particulate.

It is a still further feature of the present invention to provide a filtration system which includes a novel back-pulse system that discharges particulate captured in particulate filters to prolong the usable life of those filters for use in military land vehicles (e.g., tanks, armored vehicles) exposed to high dust environments (e.g., deserts), such that the filtration system supplies the occupants with clean air.

It is a still further feature of the present invention to provide a filtration system that reduces exposure of maintenance personnel to used filters during filter replacement.

It is a still further feature of the present invention to provide a filtration system in which the assembly or disassembly of a particulate filter to the device is separate from the assembly or disassembly of a chemical filter, and likewise each of a multiple of particulate filters are individually assembled or disassembled to the device to limit unnecessary manipulation of other components of the device during filter changes.

It is a still further feature of the present invention to provide a method of using the above-described filtration system.

It is a still further feature of the present invention to provide a method of filtering byproducts of a printing process in which particulate filtration components are separated from chemical filtration components.

Therefore, in accordance with the present invention, there is provided an apparatus for filtering particulates from a gas, comprising a casing defining an inner cavity having an inlet adapted to receive a flow of gas, such that gas enters the inner cavity, and an outlet through which gas exits the inner cavity; a filter associated with the outlet such that gas exiting the inner cavity through the outlet passes through the filter, the filter being adapted to retain particulates beyond a predetermined size from a gas flowing therethrough; and a back-pulse generator positioned downstream of the filter, the back-pulse generator being adapted to cause a reverse flow of gas through the outlet and into the inner cavity of the casing, so as to dislodge a portion of the particulates retained in the filter into the inner cavity.

Further in accordance with the present invention, there is provided an apparatus for filtering particulates and an undesired gas from a main gas, comprising a particulate treatment station having a first inlet adapted to receive a main gas carrying particulates and an undesired gas, a first filter for retaining the particulates in the particulate treatment station, the first filter being in a first casing removable from the particulate treatment station with first filter so as to reduce the exposure to the first filter when replacing the first filter, and a first outlet through which the main gas exits filtered of the particulates; a chemical treatment station and having a second inlet in fluid communication with the first outlet of the particulate treatment station so as to receive a supply of the main gas from the first outlet of the particulate treatment station, a second filter for reacting with the undesired gas to retain the undesired gas therein, and a second outlet through which the main gas exits filtered of the undesired gas; and a pressure differential system to cause a flow of the main gas through the particulate treatment station and the chemical treatment station.

Still further in accordance with the present invention, there is provided a method for removing particulates from a filter in a gas filtration system, comprising the steps of positioning a vortex generator opposite the filter such that the vortex generator faces a filtrate side of the filter; stopping a filtering flow of gas through the filter; and actuating the vortex generator so as to cause a reverse flow of gas through the filter to dislodge particulates from the filter.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a filtration system in accordance with a first embodiment of the present invention;

FIG. 2 is a perspective view, partially fragmented, of the filtration system of FIG. 1, showing an interior of a particulate treatment station;

FIG. 3 is a perspective view of a chemical treatment station of the filtration system of FIG. 1, with a cover of the chemical treatment station in an open position;

FIG. 4 is a perspective view of the chemical treatment station, with the cover in the open position, and a motor plate also in the open position to show an interior of the chemical treatment station;

FIG. 5 is a perspective view of the chemical treatment station of FIG. 4, with a filter portion shown partially removed from a motor portion;

FIG. 6 is an enlarged view of the motor plate of the chemical treatment station of FIG. 4;

FIG. 7 is a perspective view of a filtration system in accordance with a second embodiment of the present invention;

FIG. 8 is a side elevation view, partly sectioned, of the filtration system of FIG. 7;

FIG. 9 is a perspective view, partly fragmented, of a filtration system in accordance with a third embodiment of the present invention;

FIG. 10 is a perspective view, partly fragmented, of a filtration system in accordance with a fourth embodiment of the present invention;

FIG. 11A is a schematic sectional view of a back-pulse system used in a filtration system in accordance with embodiments of the present invention, during a filtration operation with a cylindrical filter;

FIG. 11B is a schematic sectional view of the back-pulse system of FIG. 11A;

FIG. 12A is a schematic sectional view of the back-pulse system of FIG. 11A, during a back-pulse operation with the cylindrical filter;

FIG. 12B is a schematic sectional view of the back-pulse system of FIG. 12A;

FIG. 13 is a schematic perspective view, fragmented, of the back-pulse system of FIG. 12A;

FIG. 14A is a schematic sectional view of a back-pulse system used with filtration systems in accordance with embodiments of the present invention, during a filtration operation with a panel filter;

FIG. 14B is a schematic sectional view of the back-pulse system of FIG. 14A, during a back-pulse operation with the panel filter;

FIG. 15 is a schematic perspective view, fragmented, of the back-pulse system of FIG. 14A;

FIG. 16 is a schematic perspective view of a filtration system having a back-pulse system of multiple vortex generators in accordance with another embodiment of the present invention;

FIG. 17 is an elevation view of a filtration system having a back-pulse system of multiple vortex generators in accordance with yet another embodiment of the present invention; and

FIG. 18 is a perspective view of an arrangement of vortex generators with respect to a cylindrical filter, in accordance with yet another embodiment of the present invention.

### DESCRIPTION OF THE PREFERRED EMBODIMENTS

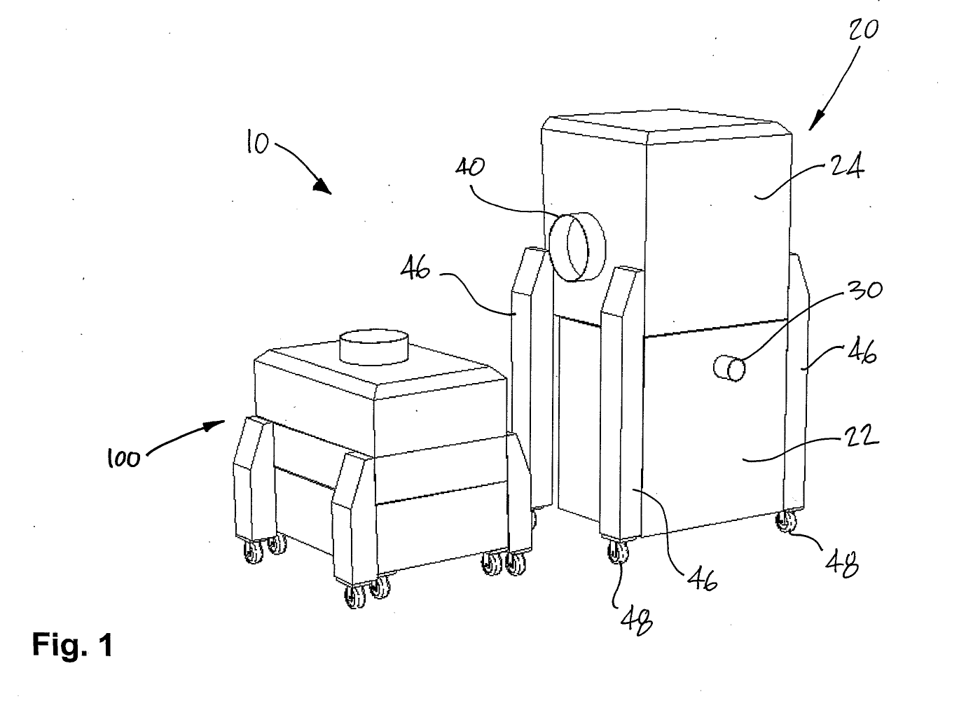

Referring to the drawings, and more particularly to FIG. 1, a filtration system in accordance with the first embodiment of the present invention is generally shown at 10. The filtration system 10 has a particulate treatment station 20 and a chemical treatment station 100.

The particulate treatment station 20 is used to filter particulates from a gas (e.g., air), so as to substantially free the gas of particulates, for instance, above a predetermined size.

The chemical treatment station 100 is used to remove a secondary unwanted gas (e.g., chemical vapors such as aldehyde and formaldehyde) from a main gas (e.g., air).

As will be described hereinafter, the particulate treatment station 20 and the chemical treatment station 100 are serially positioned with respect to one another in terms of a segment of airflow moving from one component to the other over time in accordance with a first embodiment of the present invention. More specifically, in the first embodiment, the particulate treatment station 20 is upstream of the chemical treatment station 100 for the filtration system 10. Accordingly, a gas is subjected to particulate filtration prior to being cleaned of unwanted chemical vapors.

Particulate Treatment Station 20

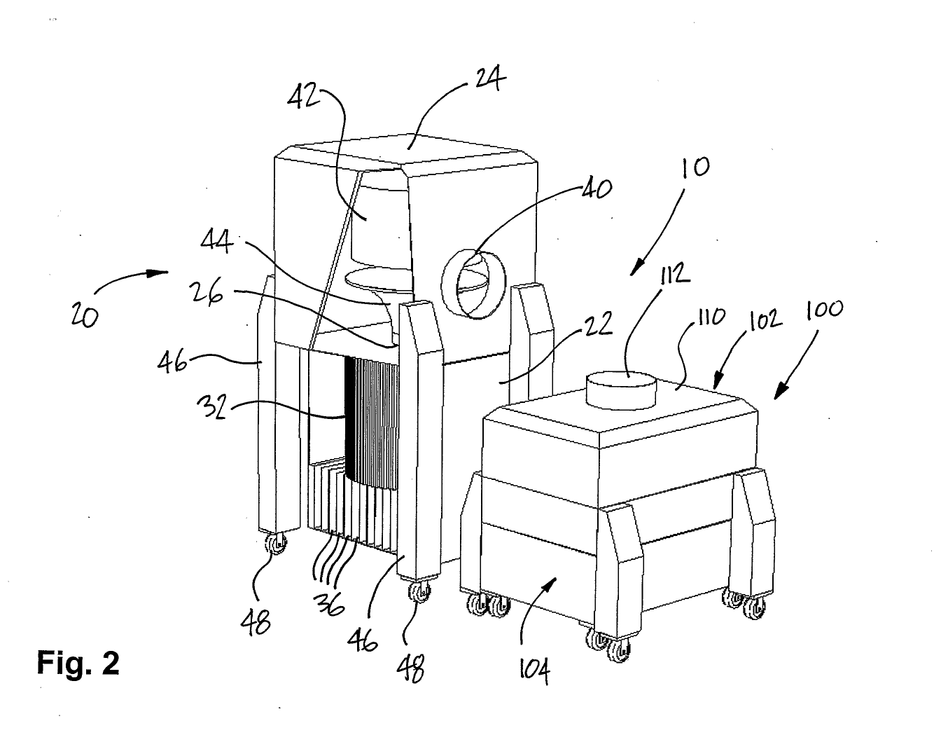

Referring concurrently to FIGS. 1 and 2, the particulate treatment station 20 in accordance with an embodiment of the present invention is shown having a first casing 22, and a second casing 24 on top of the first casing 22. As seen in FIG. 2, the first casing 22 and the second casing 24 are in fluid communication with one another through aperture 26.

The first casing 22 receives a gas input and filters the gas from particulates.

The second casing 24 exhausts the clean gas, and is used to clean the filter within the first casing 22.

Referring to FIG. 1, the first casing 22 has an inlet 30. The inlet 30 is illustrated having a tubular shape so as to be connected to a pipe or the like, to receive an inflow of a gas (e.g., air) that must be cleaned. Within the first casing 22, a cylindrical filter 32 is in an upstanding position, such that an inner cylindrical cavity of the cylindrical filter 32 is upstanding. Although not visible in FIG. 1, the inner cavity of the cylindrical filter 32 is the hollow cavity that receives the gas that has passed through the filter walls of the cylindrical filter 32 (i.e., filtrate side of the filter 32). A top circular end of the inner cavity of the cylindrical filter 32 is in register with the aperture 26 through which fluid communication occurs between the first casing 22 and the second casing 24.

At the bottom of the first casing 24, a plurality of slats 34 are positioned side by side so as to define particulate-receiving slots 36, between adjacent slots 34. The cylindrical filter 32 sits on upper ends of the slats 34. It is pointed out that the cylindrical filter 32 is sealingly connected to an upper wall of the first casing 22, such that the aperture 26 between the first casing 22 and the second casing 24 is opened only to the inner cylindrical cavity of the cylindrical filter 32. Moreover, a bottom circular end (not shown) of the inner cylindrical cavity is blocked, such that a gas that enters the inner cylindrical cavity from the first casing 22 must pass through the filter walls of the cylindrical filter 32.

As best seen in FIG. 2, the second casing 24 has an outlet 40, of tubular shape, by which the particulate treatment station 20 may be connected through a hose to the chemical treatment station 100, or to a diffuser if no chemical treatment is necessary. Alternatively, the outlet 40 may be a diffuser, once more if no chemical treatment is necessary.

The second casing 24 has a back-pulse generator 42. The back-pulse generator 42 is used to create a flow of gas from the second casing 24 through the aperture 26, and into the first casing 22. This reverse flow of gas will be received in the cylindrical cavity of the inner cylindrical filter 32, so as to exert pressure on the particulates stuck in the filter walls of the cylindrical filter 32. This will be described in further detail hereinafter.

A nozzle 44 is optionally provided in the second casing 24. The nozzle 44 is positioned between the back-pulse generator 42 and the aperture 24, so as to create an increase in flow to enhance the back-pulse of gas into the inner cavity of the cylindrical filter 32. Also, a spacer (e.g., conically shaped solid volume) may be inserted concentrically into the inner cylindrical cavity of the cylindrical filter 32, also in view of enhancing the back-pulse effect.

Operation of the Particulate Treatment Station 20

The first casing 22 of the particulate treatment station 20 receives an inflow of gas to be treated. Once received in the first casing 22, the gas will pass through the filter walls of the cylindrical filter 32, so as to reach the second casing 24 through the inner cylindrical cavity of the cylindrical filter 32 and through the aperture 26. The cylindrical filter 32 will filter out any particulate beyond a predetermined size, such that the gas going beyond the filter walls of the cylindrical filter 32 and reaching the second casing 24 is free of unwanted particles. The filtered-out particles will accumulate in the cylindrical filter 32. The cleaned-up gas will exit the second casing 24 through the outlet 40.

Periodically, a back-pulse will be triggered so as to blow the particles accumulated in the filter walls of the cylindrical filter 32 out thereof. Accordingly, the back-pulse generator 42 is activated to created a reverse flow of gas from the second casing 24 to the first casing 22 through the aperture 26. The pressure differential across the cylindrical filter 32 will build in the cylindrical filter 32 and will result in a flow of gas from the inner cylindrical cavity of the filter 32, through the filter walls of the filter 32, and into the first casing 22. This reverse flow will result in removal of the particulates out of the filter 32 and within a remainder of the first casing 22. By settling, the particulates will accumulate in the particulate-receiving slots 36.

Once a sufficient back-pulse is achieved, the flow will return to its normal direction for filtering, as described previously, with the cylindrical filter 32 having been cleaned out. It is pointed out that a blower ventilator or other flow-creating device can be positioned upstream or downstream of the particulate treatment station 20 to cause the flow of gas in the normal direction.

The particulates accumulated in the particulate-receiving slots 36 will be protected from the inflow of gas during normal operation of the particulate treatment station 20. Accordingly, air blown into the first casing 22 will be directed to the cylindrical filter 32 without entraining the particulates gathered in the particulate-receiving, slots 36.

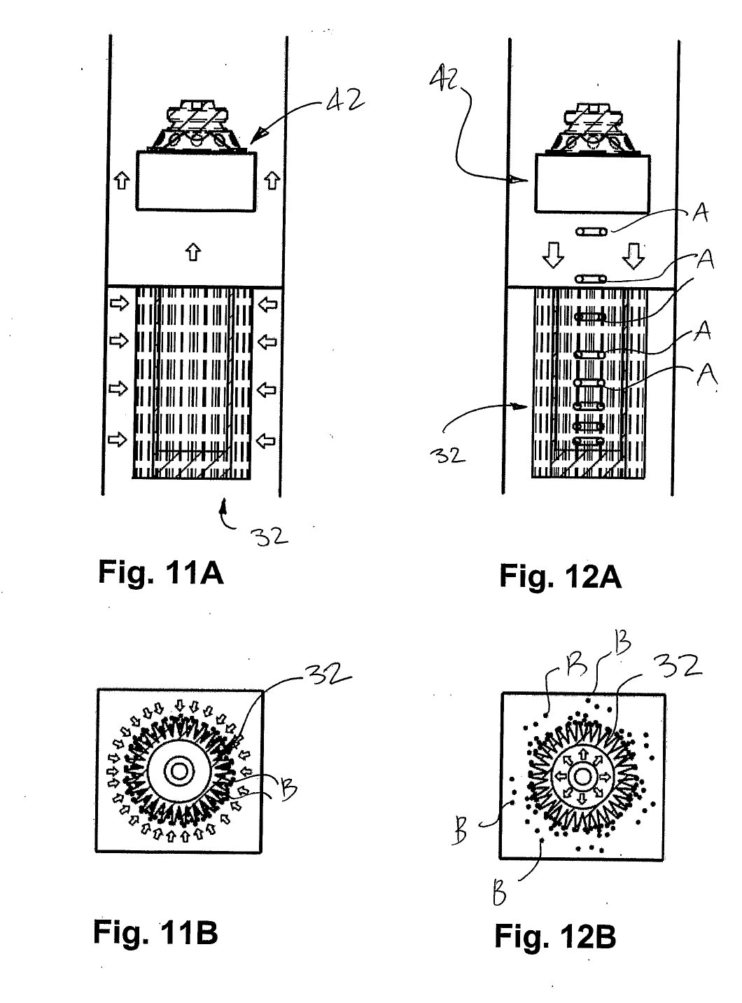

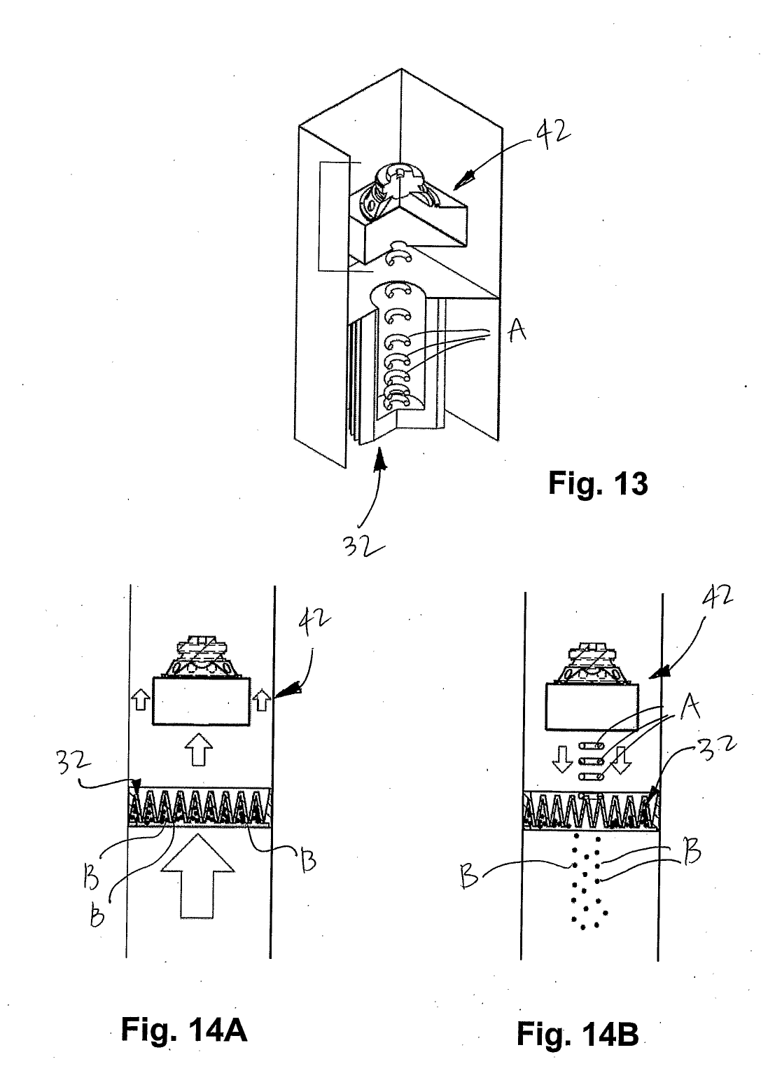

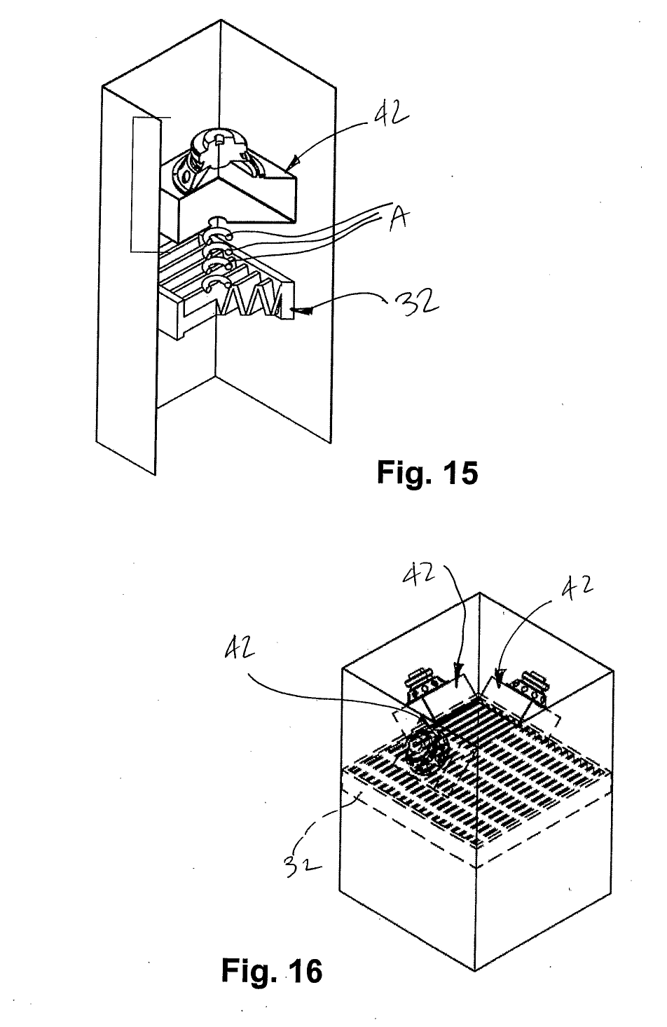

It is pointed out that the filter 32 is chosen as a function of the particulates to be removed, the strength and ability of the filter medium to withstand forces exerted thereon during back-pulsing, as well as allowable airflow restrictions for specified designs and applications. For instance, cellulose filters, HEPA filters, PTFE filters are various options of filter that are to be considered in view of the particulates to be removed. FIGS. 11A to FIG. 18 illustrate various filter configurations for vortex generators 42. As seen in FIGS. 16 to 18, it is contemplated to provide a single filter with a plurality of vortex generators 42.

Back-Pulse Generator 42

Various types of flow generators can be used for the present invention. Preferably, the back-pulse generator 42 is a vortex generator. The vortex generator turns an electrical signal into a mechanical displacement of a diaphragm at a given frequency, which will create directional flow (i.e., pulses) of the gas within the second casing 24, in the form of ring vortices. These ring vortices are schematically illustrated as A in FIGS. 12A, 13, 14B and 15, and strike a surface of the filter, thereby exerting a force on the particulates B lodged in the filter. Additionally, the pulses of gas cause a vibration of the filtration system. According to the pulse frequency, the vibrating effect resulting on the filter will also cause particulates to become dislodged from the filter.

Therefore, the vortex generator is well suited to act as back-pulse generator 42, as it may be positioned directly above the aperture 26 so as to create a flow of gas through the aperture 26 and into the cylindrical filter 32. Moreover, the use of a vortex generator is advantageous in that it only requires an electrical signal to be operative, and is a low-maintenance system. The vortex generator will entrain the particulate-free gas from the second casing 24 into the first casing 22. Moreover, it is considered that the vortex generator creates a vibration that can dislodge particles from the cylindrical filter 32.

Although speakers are illustrated as being used as vortex generators, other vortex generators can be used to generate pulses of gas in a plenum. For instance, electromechanical devices driving diaphragms are considered.

The particulate treatment station 20 of the present invention is advantageous in that no maintenance manpower is required to change filters. The particulates received in the cylindrical filter 32 are often hazardous to health, whereby it is advantageous to limit the exposure to these particulates. Therefore, it is contemplated to make the first casing 22 disposable, such that, after a given amount of time using the filter 32 within the first casing 22, another first casing 22 replaces the previous one. As shown in FIGS. 1 and 2, the second casing 24 has legs 46, at the bottom of which are provided casters 48 so as to facilitate the separation of the first casing 22 from the second casing 24. Moreover, the first casing 22 may also be provided with casters to facilitate the disposal thereof. The particulate treatment station 20 of the present invention increases the life of the filter by cleaning the latter, thereby limiting the necessity of a filter change. This results in a decrease in costs of filters. A fastening mechanism, such as latches, is used to secure the first casing 22 to the second casing 24. It is also contemplated to provide the filters used with the back-pulse generator with a low-adherence coating, to facilitate dislodging of particulates from the filters.

It is also pointed out that the distance between the back-pulse generator 42 and the surface of the filter or any deflective surface (e.g., nozzle 44) is dependent on the speed, diameter and volume of the ring vortices caused by the back-pulse generator 42.

Chemical Treatment Station 100

Referring to FIG. 1, the chemical treatment station 100 is shown positioned adjacent to the particulate treatment station 20. The chemical treatment station 100 receives a flow of gas free of unwanted particulates, and will clean the flow of gas from undesired chemical vapors. The chemical treatment station 100 therefore has active filter elements, as will be described hereinafter.

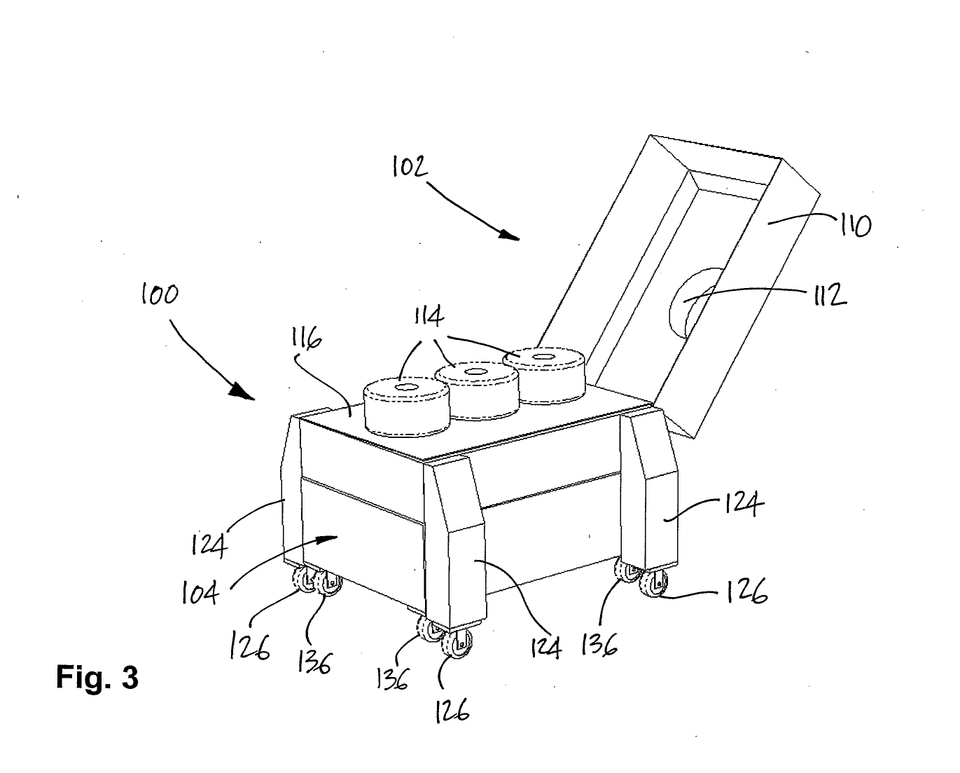

Referring to FIG. 3, the chemical treatment station 100 is shown having a motor portion 102 and a filter portion 104. In the illustrated embodiment, the motor portion 102 is positioned on top of the filter portion 104. The motor portion 102 is a flow generator, creating a pressure differential that will cause a flow of gas (i.e., air) through the chemical treatment station 100. In the illustrated embodiment, it is also the motor portion 102 that causes the flow of air through the particulate treatment station 20, for the removal of particulates from the air.

The chemical treatment station 100 has a cover 110 having an inlet 112. The inlet 112 is of tubular shape so as to be interconnected to the outlet 40 (FIGS. 1 and 2) of the particulate treatment station 20, for instance by a flexible duct or other similar conduit. Accordingly, an outflow of gas from the particulate treatment station 20 will reach the chemical treatment station 100 through the inlet 112.

The cover 110, shown in an open position in FIGS. 3 to 6, is hinged to a remainder of the motor portion 102, such that a top end of motors 114 of the motor portion 102 can be accessed. Other configurations are possible (e.g., the cover 110 may be removable from a remainder of the motor portion 102, and be latched when connected thereto).

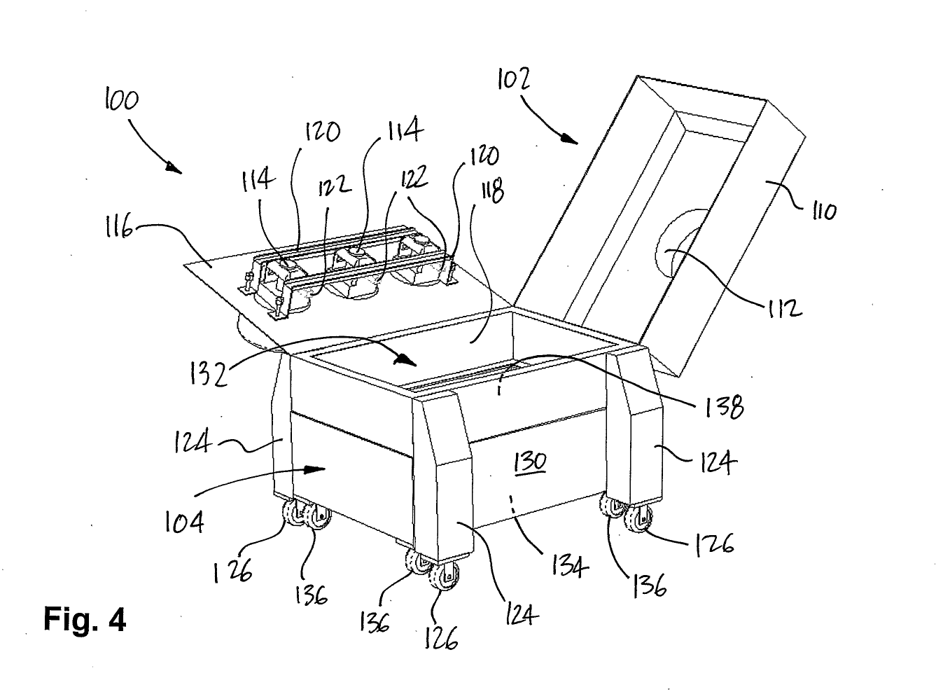

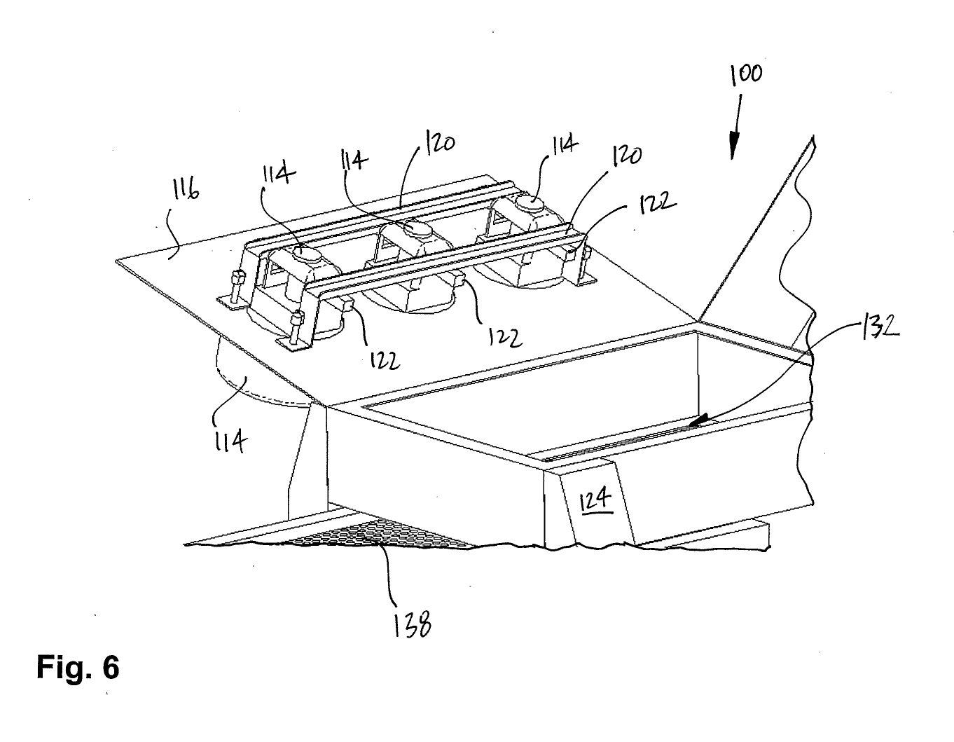

Referring to FIG. 4, the motors 114 are on a plate 116 that is also hinged to a remainder of the motor portion 102, whereby an underside of the motors 114 may be accessed. As an example, the motors 114 are Ametek Lamb Electric vacuum motors. The contact elements (i.e., brushes) of such motors must be changed on a periodic basis, and various steps are involved in changing these contact elements. For instance, the contact elements are retained on the motor chassis with threaded fasteners, which must be unsecured for a changing of contact elements. Accordingly, a changing of contact elements requires a nonnegligible maintenance time. Accordingly, as best shown in FIG. 6, brackets 120 support a plurality of contact elements 122, such that the contact elements 122 are in contact with the motors 114. The brackets 120 are fastened to plate 116 with threaded fasteners so as to be removable from a first position, as illustrated in FIG. 6, in which the contact elements 122 are in contact with the motors 114, and a second position in which the contact elements 122 are away from the motor 114, whereby they can readily be removed.

Returning to FIG. 4, the plate 116 is flipped open to its open position to expose the inner cavity 118 of the motor portion 102. Gas (i.e., air) will flow through the inner cavity 118 to reach the filter portion 104. The filter portion 104 encloses filters/filtration systems that are associated with the byproduct chemical vapors that are to be removed from the main gas (e.g., air in the present case). Examples of the types of filters/filtration systems include active carbon filters and other chemical and odor filters, to remove gases such as aldehyde, formaldehyde, acrolein.

The filter portion 104 has a casing 130 having an inlet face 132 and an outlet face 134. The casing 130 is on casters 136, so as to be displaced. The previously described filters/filtration systems are generally shown at 138, between the inlet face 132 and the outlet face 134, whereby gas/air exiting the filter portion 104 by the outlet face 134 will have gone through the filters/filtration systems 138.

It is required to change the filters/filtration systems 138 on a periodic basis. It is, however, desired to limit the exposure of maintenance personnel to the filters/filtration systems 138, as some types of these filters are toxic. Advantageously, particulates have been removed from the gas to be treated in the particulate treatment station 20, whereby no dust filters are required to be replaced in this embodiment of the present invention.

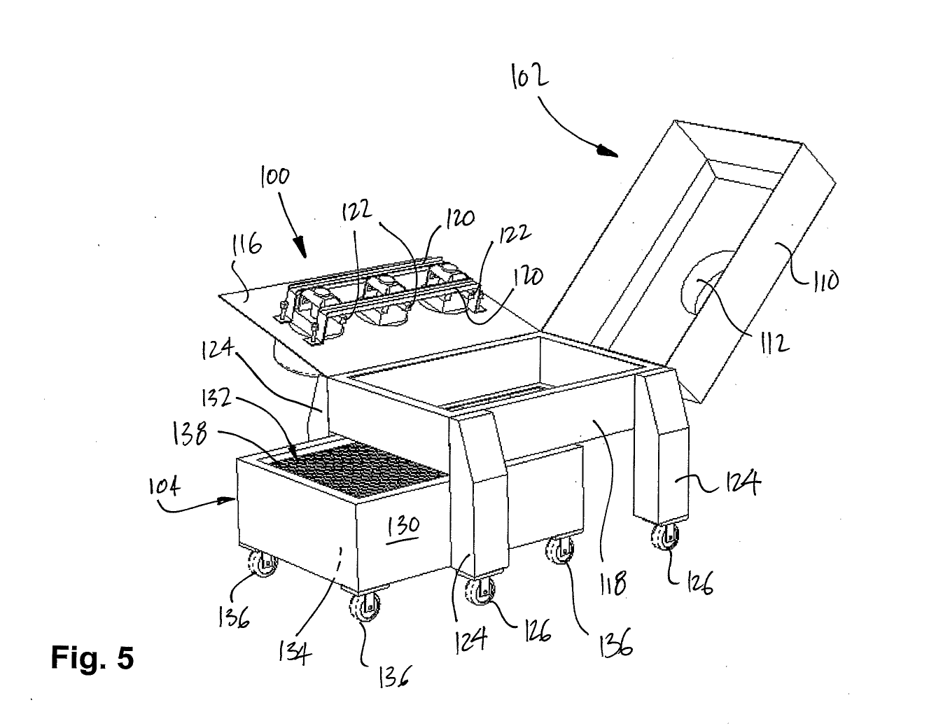

Accordingly, the filters/filtration systems 138 are to be disposed of along with the filter portion 104 when required. More specifically, as shown in FIG. 5, the motor portion 102 is on legs 124, at the bottom of which casters 126 are provided. Accordingly, the motor portion 102 can be displaced away from the filter portion 104. The motor portion 102 and the filter portion 104 can be secured to one another using mechanical locks, such as latch mechanisms (not shown).

Therefore, when the filters/filtration systems 138 must be replaced, the casing 130 is rolled away and completely replaced by another one. As the particulates have been removed in the particulate treatment station 20, maintenance personnel attending to the motors 114 are not exposed to dirty particulate filters, which accumulate in such motors when particulate filtration occurs downstream of these motors. Moreover, as the maintenance steps required for the chemical treatment station 100 are simplified in the present invention, the downtime due to the maintenance of the filtration system 10 is reduced.

### Second Embodiment of the Present Invention

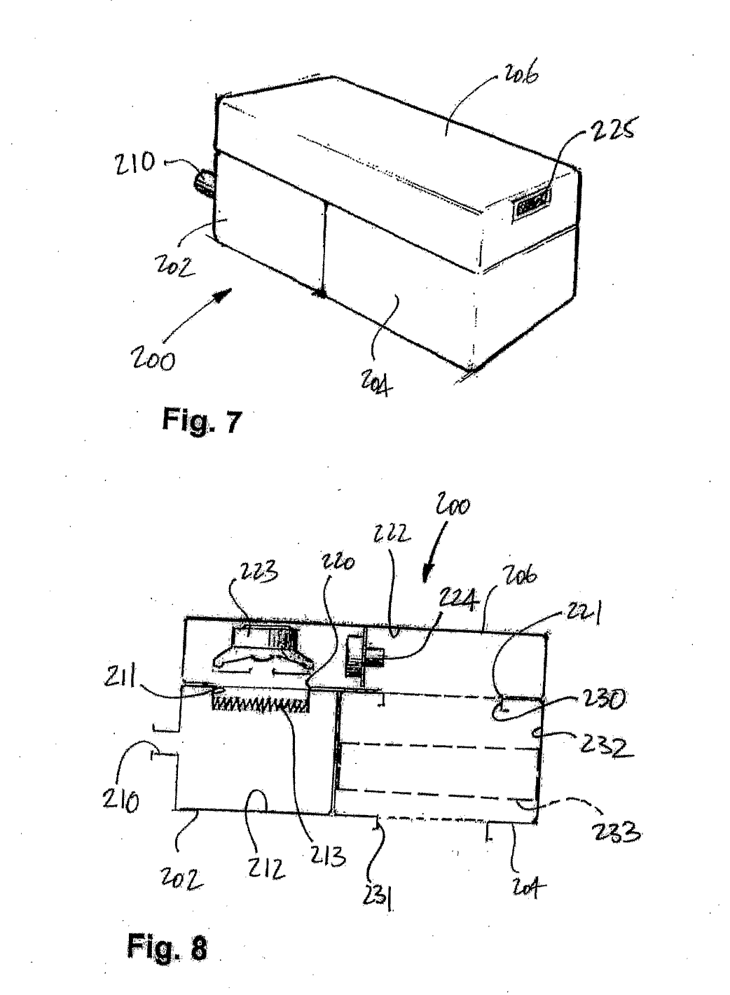

Referring to the drawings, and more particularly to FIGS. 7 and 8, a filtration system in accordance with a second embodiment of the present invention is generally shown at 200. The filtration system 200 has a particulate treatment casing 202, a chemical treatment casing 204 and a motor unit 206.

The particulate treatment casing 202 is used to filter particulates from a gas (e.g., air), so as to substantially free the gas of particulate, for instance, above a predetermined size. The chemical treatment casing 204 is used to remove a secondary unwanted gas (e.g., chemical vapors such as aldehyde and formaldehyde) from a main gas (e.g., air). The motor unit 206 is used to generate a flow of the main gas through the filtration system 200, as well as to create a back-pulse in order to remove particulate from a filter of the particulate treatment casing 202.

Referring to FIG. 8, the particulate treatment casing 202 is shown having an inlet 210, an outlet 211 and an inner cavity 212. A main gas to be filtered (e.g., air) enters the inner cavity 212 through the inlet 210 and exits the inner cavity 212 through the outlet 211 in a normal filtering operation of the filtration system 20. A filter 213 blocks the outlet 211 such that air exiting the particulate treatment casing 202 through the outlet 211 must be filtered by the filter 213. The filter 213 may be various types, as described previously for the first embodiment, and is chosen as a function of the particulate to remove from the air.

Although not shown, particulate-capturing means, such as the slats 34/slots 36 of the first embodiment (e.g., as shown in FIG. 2), are provided at a bottom of the inner cavity 212 of the particulate treatment casing 202. Accordingly, the particulates removed by back-pulse from the filter 213 are captured in these means so as to prevent resaturation of the filter with these particulates.

Referring to FIG. 8, the motor unit 206 has an inlet 220 in fluid communication with the outlet 211 of the particulate treatment casing 202. The motor unit 206 has an outlet 221 and defines an inner cavity 222 through which the main gas (air) flows from the inlet 220 to the outlet 221 in the normal filtering operation of the filtration system 200. The motor unit 206 has a back-pulse generator 223 opposite the inlet 220, so as to generate a back-pulse through the outlet 211 and filter 213 of the particulate treatment casing 202, to remove particulates clogging up the filter 213. As mentioned previously, the back-pulse generator 223 is a ring vortex generator (as illustrated in FIG. 8, at 223).

The inner cavity 222 also encloses a flow generator 224 (i.e., a vacuum, a blower, a fan or the like) to cause the flow of the main gas within the filtration system 200. It is pointed out that the flow generator 224 is positioned downstream of the filter 213, whereby particulates will generally be removed from the main gas (air) upon reaching the flow generator 224.

As seen in FIG. 7, the motor unit 206 has handles, one of which is shown at 225, for handling the filtration system 200 as a whole, or the motor unit 206.

Referring to FIG. 8, the chemical treatment casing 204 has an inlet 230, an outlet 231, and an inner cavity 232 through which the main gas flows from the inlet 230 to the outlet 231. A chemical vapor filter 233 is enclosed in the inner cavity 232. The inlet 230 of the chemical treatment casing 204 is in fluid communication with the outlet 221 of the motor unit 206.

Accordingly, the main gas (air), having entered the filtration system 200 through the inlet 210, is filtered in the particulate treatment casing 202. The flow generator 224 causes the air to flow from the particulate treatment casing 202 through the motor unit 206 and into the chemical treatment casing 204. Accordingly, the particulate treatment casing 202 and the chemical treatment casing 204 are secured to the motor unit 206 and sealed thereto in order for the flow of air to remain contained within the particulate casing 202 and chemical treatment casing, permitting the flow of air to pass through only inlet 210, the filter 213, the inlet 230, and the outlet 231.

The air is filtered from particulates in the particulate treatment casing 202 and is conveyed to the chemical treatment casing 204, whereat chemical vapors will be adsorbed by the chemical vapor filter 233.

When the filter 213 of the particulate treatment 202 is saturated with particulates (e.g., the pressure differential across the filter 213 is beyond a given limit), a back-pulse is initiated by the back-pulse generator 223, whereby filtered air within the motor unit 206 and/or the chemical treatment casing 204 will follow a reverse direction into the particulate treatment casing 202, so as to free the filter 213 from a portion of the particulates.

It is pointed out that the filtration system 200 is modular in that the motor unit 206 may be separated from the particulate treatment casing 202 and the chemical treatment casing 204. Accordingly, when the particulate treatment casing 202 and/or the chemical treatment casing 204 require changing, these may be removed from the motor unit 206. Latch mechanisms or the like may be used to releasably secure the motor unit 206 to the particulate treatment casing 202 and the chemical treatment casing 204.

### Third Embodiment of the Present Invention

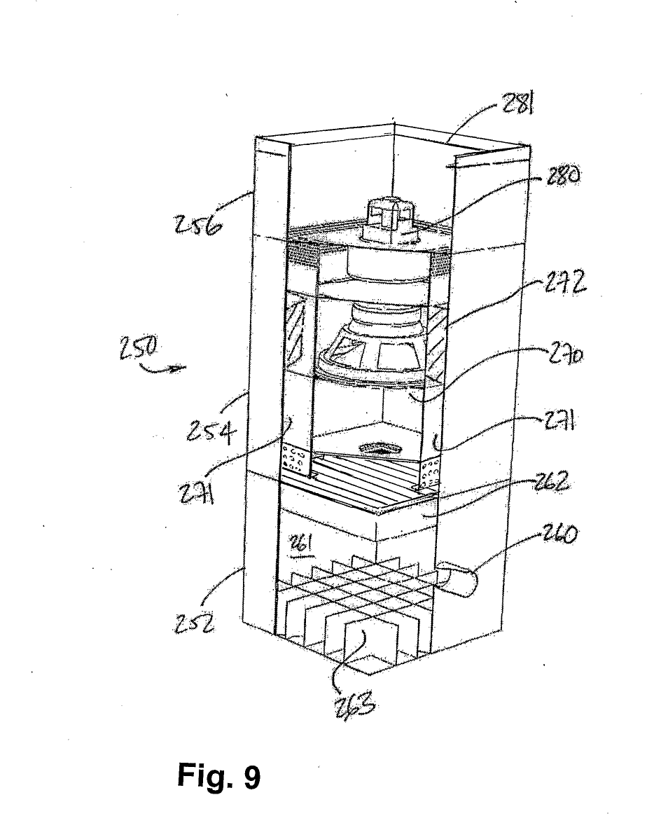

Referring to FIG. 9, a filtration system in accordance with a third embodiment of the present invention is generally shown at 250. The filtration system 250 has a particulate treatment section 252, a chemical treatment section 254 and a motor unit section 256.

The particulate treatment section 252 has an inlet 260, an inner cavity 261, a filter 262 at a top end of the inner cavity 261, and means 263 for capturing particulates.

The chemical treatment section 254 is positioned on top of the particulate treatment section 252, and is in fluid communication therewith. Accordingly, a main gas (air) that is filtered through the filter 262 of the particulate treatment section 252 is received in the chemical treatment section 254. A back-pulse generator 270 is centered in the chemical treatment section 254 and faces towards the filter 262 of the particulate treatment section 252. In FIG. 9, the back-pulse generator 270 is illustrated as a ring vortex generator. An annular plenum 271 is defined between the back-pulse generator 270 and an inner wall of the chemical treatment section 254 optionally, a chemical vapor filter 272 may be received therein so as to adsorb chemical vapor present in the main gas being filtered, if required. In some instances, it may only be required to filter out particulates from the main gas.

The motor unit section 256 is positioned on top of the chemical treatment section 254 and has a flow generator 280 so as to create a flow of the main gas through the filtration system 250. The air exits from the motor unit section 256 through the outlet 281.

In operation, the filtration system 250 of the third embodiment of the present invention has the flow generator 280 causing a flow of the main gas, (e.g., air) from the inlet 260 to the outlet 281. Particulates will be caught by the filter 262 of the particulate treatment section 252. The main gas will then reach the annular plenum 271, wherein the chemical vapor filter 272, if present, will remote unwanted chemical vapor. Thereafter, the main gas will exit through the outlet 281, having been subjected to the necessary treatments.

When the filter 262 becomes saturated with particulates, the back-pulse generator 270 is activated in order to create a reverse flow of the main gas through the filter 262. The particulates will be captured in the means 263, so as not to resaturate the filter 262.

The particulate treatment section 252, the chemical treatment section 254 and the motor unit section 256 are sealingly interconnected in order to prevent the main gas from exiting or entering at the interconnection between respective sections. For instance, latch mechanisms or other like mechanisms can be used to secure the sections 252, 254 and 256 to one another.

### Fourth Embodiment of the Present Invention

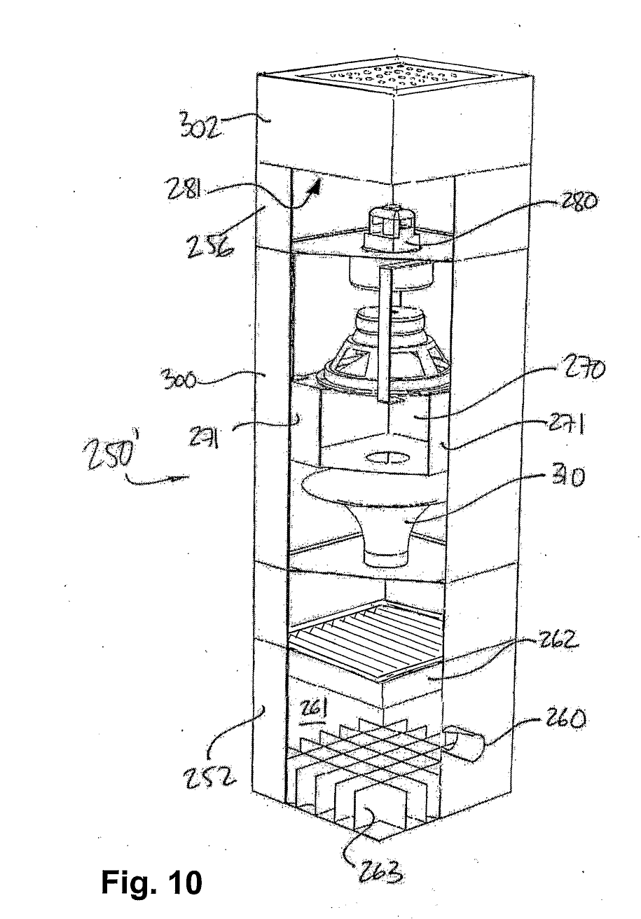

Referring to FIG. 10, a filtration system in accordance with a fourth embodiment of the present invention is generally shown at 250′. The filtration system 250′ is similar to the filtration system 250 of FIG. 9, but differs in that additional sections are provided. Accordingly, like elements will bear like reference numerals between FIGS. 9 and 10.

The filtration system 250′ has the particulate treatment section 252 and the motor unit section 256. The particulate treatment section 252 has the inlet 260, the inner cavity 261, the filter 262 and the means 263 for capturing the particulates. The motor unit section 256 has the flow generator 280 and an outlet 281 at a top end thereof.

The chemical treatment section 254 (FIG. 9) of the third embodiment has been replaced by a back-pulse section 300. Also, a chemical treatment section 302 is positioned on top of the outlet 281 of the motor unit section 256.

The back-pulse section 300 has a back-pulse generator 270 and a nozzle 310 between the back-pulse generator 270 and the filter 262. The nozzle 310 is used to render the back-pulse from the back-pulse generator 270 more effective in removing particulates from the filter 262. The back-pulse section 300 also has the annular plenum 271, which, however, does not include any chemical vapor filter. The chemical vapor filter is present in the chemical treatment section 302, which is positioned on top of the motor unit section 256.

It is pointed out that the sections 252, 256, 300 and 302 of the filtration system 250′ are separable from one another such that the filter portions can be changed and mechanical and electrical components can be accessed for service or replacement.

The filtration system 250′ operates in similar fashion to the filtration system 250 of the third embodiment (FIG. 9). More specifically, the flow generator 280 creates a flow of a main gas (e.g., air), such that the gas with particulates and chemical vapor firstly passes through the particulate treatment section 252, whereat particulates are retained by the filter 262. Thereafter, the air is conveyed through the nozzle 310, through the annular plenum 271 and through the motor unit section 256 to reach the chemical treatment section 302, whereat chemical vapors and other unwanted gases will be removed from the main gas.

When the filter 262 of the particulate treatment section 252 becomes saturated with particulates, a back-pulse is triggered with the back-pulse generator 270 (herein illustrated as a ring vortex generator) creating a reverse flow that will remove particulates from the filter 262. The particulates are captured in the means 263 so as not to resaturate the filter 262.

The modular assembly of the filtration system 250′ facilitates the removal of the particulate treatment section 252 and the chemical treatment section 302 when it comes time to replace the filters. The sections 252, 256, 300 and 302 are sealingly secured to one another (for instance, using latch mechanisms, gaskets and other means) in order to ensure that the main gas does not exit through the interconnection between these various sections.

The second, third and fourth embodiments are advantageous when used in situations where space is an issue. For example, vehicles (e.g., military vehicles) often require filtration systems according to the environment to which they are exposed (e.g., desert). The embodiments of FIGS. 7 to 10 provide a space-efficient solution. Moreover, these embodiments may operate from a single electrical source, using a vortex generator. As vehicles are typically provided with electrical systems, the embodiments of FIGS. 7 to 10 are well suited therefor.

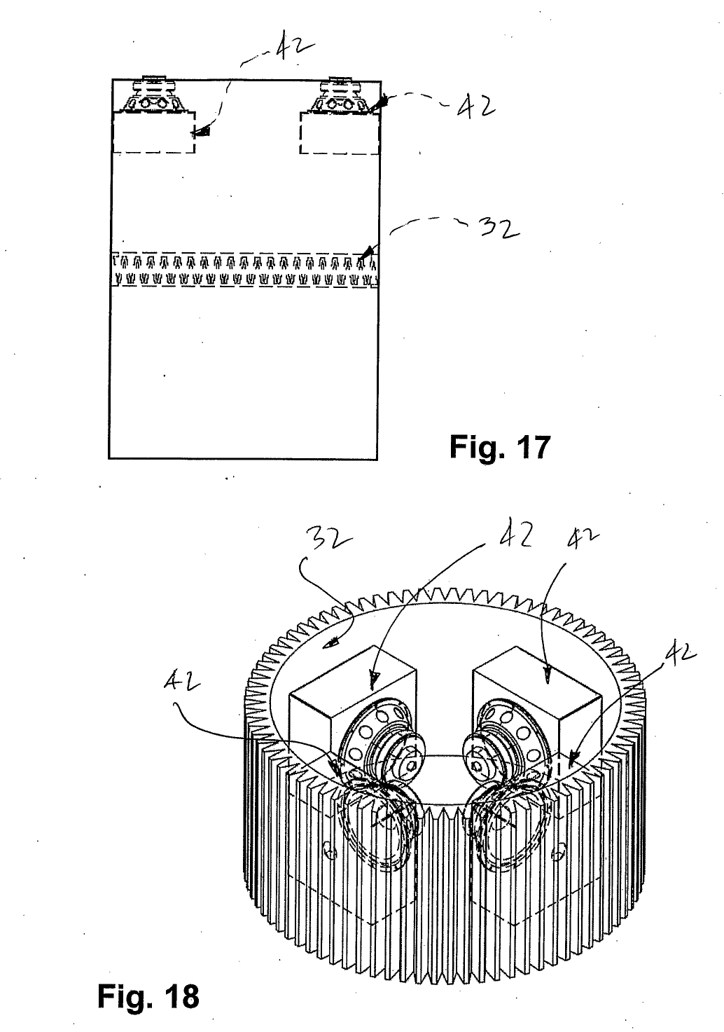

In FIG. 16, a plurality of vortex generators 42 are used, and are centered toward a focal point on the filter 32. This increases the force exerted on the focal point of the filter. In FIGS. 17 and 18, a plurality of vortex generators 42 are used to dislodge particulates from a larger-area filters.

1. An apparatus for filtering particulates from a gas, comprising:
a casing defining an inner cavity having an inlet adapted to receive a flow of gas, such that gas enters the inner cavity, and an outlet through which gas exits the inner cavity;
a filter associated with the outlet such that gas exiting the inner cavity through the outlet passes through the filter, the filter being adapted to retain particulates beyond a predetermined size from a gas flowing therethrough; and
a back-pulse generator positioned downstream of the filter, the back-pulse generator having a diaphragm actuatable to induce a flow of gas, the diaphragm being oriented such that actuation of the diaphragm causes a reverse flow of gas through the outlet and into the inner cavity of the casing, so as to dislodge a portion of the particulates retained in the filter into the inner cavity.

2. The apparatus of claim 1, further comprising means for accumulating the portion of particulates dislodged from the filter.

3. The apparatus of claim 2, wherein the means are slots in a bottom of the casing.

4. The apparatus according to claim 3, wherein the inlet is generally parallel to the bottom of the casing.

5. The apparatus according to claim 1, further comprising a flow generator within the inner cavity of the casing to cause the flow of gas from the inlet to the outlet.

6. The apparatus according to claim 5, wherein the flow generator is downstream of the back-pulse generator.

7. The apparatus according to claim 1, wherein the casing has a casing portion detachable from a remainder of the casing, the casing portion having the filter and the inlet.

8. The apparatus according to claim 1, further comprising a chemical treatment filter in the inner cavity downstream of the back-pulse generator.

9. The apparatus according to claim 1, further comprising a nozzle between the filter and the vortex generator, so as to enhance an effect of the reverse flow on the filter.

10. The apparatus according to claim 1, wherein the filter has a low adherence coating on a filtering side thereof.

11. The apparatus according to claim 1, wherein the back-pulse generator is a ring vortex generator.

12. The apparatus according to claim 11, comprising a plurality of the ring vortex generator.

13. A method for removing particulates from a filter in a gas filtration system, comprising the steps of:
positioning a ring vortex generator opposite the filter such that the ring vortex generator faces a filtrate side of the filter;
stopping a filtering flow of gas through the filter; and
actuating the ring vortex generator so as to cause a reverse flow of gas through the filter to dislodge particulates from the filter.

14. An apparatus for filtering particulates and an undesired gas from a main gas, comprising:
a particulate treatment station enclosed in a first casing and having a first inlet adapted to receive a main gas carrying particulates and an undesired gas, a first filter for retaining the particulates in the particulate treatment station, the first filter being in a first casing removable from the particulate treatment station with first filter so as to reduce the exposure to the first filter when replacing the first filter, and a first outlet through which the main gas exits filtered of the particulates;
a chemical treatment station enclosed in a second casing physically separated from the first casing and having a second inlet in fluid communication with the first outlet of the particulate treatment station so as to receive a supply of the main gas from the first outlet of the particulate treatment station, a second filter for reacting with the undesired gas to retain the undesired gas therein, and a second outlet through which the main gas exits filtered of the undesired gas; and
a pressure differential system to cause a flow of the main gas through the particulate treatment station and the chemical treatment station.

15. The apparatus according to claim 14, wherein the first outlet and the second inlet are interconnected by a conduit such that the particulate treatment station and the chemical treatment station are separated from one another.

16. The apparatus according to claim 14, wherein the second filter is in a subcasing associated with the second casing of the chemical treatment station, the subcasing being removable from the chemical treatment station with the second filter so as to reduce the exposure to the second filter when replacing the second filter.

17. The apparatus according to claim 14, wherein the pressure differential system has at least one brush motor within the chemical treatment station.

18. The apparatus according to claim 17, wherein the at least one brush motor is mounted on a hinged plate within the chemical treatment station, such that both sides of the brush motor are readily accessible.

19. The apparatus according to claim 17, wherein contact elements for the brush motor are secured to a bracket, the bracket being releasably connected to the chemical treatment station.

20. The apparatus according to claim 14, wherein at least one of the first casing and the second casing is on casters.

21. The apparatus according to claim 16, wherein the subcasing is on casters.
